(19) United States
(12) Patent Application Publication
(10) Pub. No.: US 2013/0006644 A1
(43) Pub. Date: Jan. 3, 2013

(54) METHOD AND DEVICE FOR SPECTRAL BAND REPLICATION, AND METHOD AND SYSTEM FOR AUDIO DECODING

(75) Inventors: Dongping Jiang, Shenzhen City (CN); Hao Yuan, Shenzhen City (CN); Guoming Chen, Shenzhen City (CN); Ke Peng, Shenzhen City (CN); Jiali Li, Shenzhen City (CN)

(73) Assignee: ZTE CORPORATION, Shenzhen City (CN)

(21) Appl. No.: 13/173,085

(22) Filed: Jun. 30, 2011

(51) Int. Cl. G10L 19/00

(52) U.S. Cl. 704/500; 704/E19.001

(57) ABSTRACT

The present invention relates to a method and device for spectral band replication, and a method and system for audio decoding, and the method for spectral band replication comprises: A. searching for the position of a certain tone of an audio signal in MDCT frequency domain coefficients; B. according to the tone position, determining a spectral band replication period which is a bandwidth from a 0 frequency point to a frequency point of tone position, and a source frequency segment which is a frequency segment from a frequency point of the 0 frequency point shifting copyband_offset frequency points backwards to a frequency point of the frequency point of the tone position shifting the copyband_offset frequency points backwards, wherein said offset copyband_offset is greater than or equal to 0; and C. according to the spectral band replication period, carrying out spectral band replication on zero bit encoding subbands.

### TECHNICAL FIELD

The present invention relates to an audio decoding technique, and particularly, to a method and device for spectral band replication of spectrum reconstruction on uncoded encoding subband, and a method and system for audio decoding.

### BACKGROUND OF THE RELATED ART

The audio encoding technique is the core of the multimedia application techniques such as the digital audio broadcast, Internet propagation music and audio communication and so on, and these applications will greatly benefit from the improvement of the compression performance of the audio encoder. The perceptual audio encoder acts as a kind of the lossy transform domain encoding, and is a modern mainstream audio encoder. Generally, because of the limitation of the encoding bit rate, parts of the frequency domain coefficients or frequency components can not be encoded during the audio encoding, and in order to better recover the spectrum components of the uncoded subbands, current audio encoders and decoders generally use a method for the noise filling or spectral band replication to reconstruct the spectrum components of the uncoded subband. The G722.1C adopts the method for the noise filling, the HE-AAC-V1 adopts the spectral band replication technique, and the G.719 adopts the method for the combination of noise filling and simple spectral band replication. Adopting the method for noise filling is unable to well recover the spectrum envelop of the uncoded subband and the tone and noise components inside the subband. The method for the spectral band replication of the HE-AAC-V1 is required to analyze the spectrum of the audio signal before encoding, estimate the tone and noise of the high frequency component signals, extract parameters, and after down sampling the audio signal, use the AAC encoder to carry out the encoding, which has high calculation complexity, and is required to transmit more parameter information to the decoding end, occupies more encoded bits, and at the same time, also increases the encoding delay. However, the replication scheme of the G.719 is too simple to well recover the spectrum envelop of the uncoded subbands and the tone and noise components inside the subband.

### SUMMARY OF THE INVENTION

The technical problem to be solved in the present invention is to provide a method and device for spectral band replication, and a method and system for audio decoding, which is for well solving the problem of the recovery of the audio signal of uncoded encoding subbands during the audio encoding and decoding processes.

In order to solve the above technical problem, the present invention provides a method for spectral band replication, and this method comprises:

A. searching for position of a certain tone of an audio signal in MDCT frequency domain coefficients;

B. according to the tone position, determining a spectral band replication period and a source frequency segment, this spectral band replication period being a bandwidth from a 0 frequency point to a frequency point of a tone position, and this source frequency segment being a frequency segment from a frequency point of the 0 frequency point shifting copyband_offset frequency points backwards to a frequency point of the frequency point of tone position shifting the copyband_offset frequency points backwards, wherein said offset copyband_offset is greater than or equal to 0;

C. according to the spectral band replication period, carrying out spectral band replication on zero bit encoding subbands.

Preferably, in the step A, the following method is adopted to search for the position of the certain tone:

taking absolute values or square values of the frequency domain coefficients of a first frequency segment and carrying out smoothing filtering; and

according to a result of the smoothing filtering, searching for position of a maximum extreme value of first frequency segment filtering outputs, and taking the position of this maximum extreme value as the position of a certain tone.

Preferably, an operation formula of taking the absolute values of frequency domain coefficients of the first frequency segment to carry out the smoothing filtering is as follows:

X_ampᵢ(k)=μX_ampᵢ₋₁(k)+(1−μ)| X̅ᵢ(k)|

or an operation formula of taking the square values of frequency domain coefficients of the first frequency segment to carry out the smoothing filtering is as follows:

X_ampᵢ(k)=μX_ampᵢ₋₁(k−1)+(1−μ) X̅ᵢ(k)²

wherein μ is a smoothing filtering coefficient, X_ampᵢ(k) denotes filtering outputs of the kth frequency point of the ith frame, and X̅ᵢ(k) are MDCT coefficients after decoding of the kth frequency point of the ith frame, and when i=0, X_ampᵢ₋₁(k)=0.

Preferably, said first frequency segment is a frequency segment of low frequencies of which energy is more centralized determined according to spectrum statistic characteristic, wherein low frequencies refer to spectrum components less than half of total bandwidth of a signal.

Preferably, the following method is adopted to determine the maximum extreme value of filtering outputs: directly searching for an initial maximum value from filtering outputs of frequency domain coefficients corresponding to the first frequency segment, and taking this maximum value as the maximum extreme value of filtering outputs of the first frequency segment.

Preferably, the following method is adopted to determine the maximum extreme value of filtering outputs:

taking a segment in the first frequency segment as a second frequency segment, and searching for an initial maximum value from the filtering outputs of the frequency domain coefficients corresponding to the second frequency segment, and according to a position of the frequency domain coefficient corresponding to this initial maximum value, carrying out different processes:

a. if this initial maximum value is the filtering output of the frequency domain coefficient of the lowest frequency of the second frequency segment, comparing this filtering output of the frequency domain coefficient of the lowest frequency of the second frequency segment with the filtering output of the frequency domain coefficient of a former one lower frequency in the first frequency segment, and comparing forwards in sequence, until the filtering output of the current frequency domain coefficient is greater than the filtering output of a former one frequency domain coefficient, and the filtering output of the current frequency domain coefficient being a finally determined maximum extreme value, or, comparing until the filtering output of the frequency domain coefficient of the lowest frequency of the first frequency segment is greater than the filtering output of a latter one frequency domain coefficient, and the filtering output of the frequency domain coefficient of the lowest frequency of the first frequency segment being the finally determined maximum extreme value;

b. if this initial maximum value is the filtering output of the frequency domain coefficient of the highest frequency of the second frequency segment, comparing this filtering output of the frequency domain coefficient of the highest frequency of the second frequency segment with the filtering output of the frequency domain coefficient of a latter one higher frequency in the first frequency segment, and comparing backwards in sequence, until the filtering output of the current frequency domain coefficient is greater than the filtering output of a latter one frequency domain coefficient, and the filtering output of the current frequency domain coefficient being the finally determined maximum extreme value, or, comparing until the filtering output of the frequency domain coefficient of the highest frequency of the first frequency segment is greater than the filtering output of a former one frequency domain coefficient, and the filtering output of the frequency domain coefficient of the highest frequency of the first frequency segment being the finally determined maximum extreme value;

c. if this initial maximum value is the filtering output of the frequency domain coefficient between the lowest frequency and the highest frequency in the second frequency segment, the frequency domain coefficient corresponding to this initial maximum value being the tone position, namely, this initial maximum value being the finally determined maximum extreme value.

Preferably, in step C, when the spectral band replication is carried out for a zero bit encoding subband, according to the source frequency segment and a starting sequence number of the zero bit encoding subband which requires spectral band replication, firstly a source frequency segment replication starting sequence number of this zero bit encoding subband is calculated, and then the spectral band replication period is taken as a period, and starting from the source frequency segment replication starting sequence number, frequency domain coefficients of the source frequency segment are periodically replicated to the zero bit encoding subband.

Preferably, in step C, a method for calculating the source frequency segment replication starting sequence number of the zero bit encoding subband is:

obtaining a sequence number of a frequency point of a start MDCT frequency domain coefficient of the zero bit encoding subband which requires reconstructing frequency domain coefficients, which is denoted as a fillband_start_freq, and a sequence number of a frequency point corresponding to the tone being denoted as a Tonal_pos, a spectral band replication period being denoted as a copy_period, of which a value is equal to the Tonal_pos plus 1, and a spectral band replication offset being denoted as the copyband_offset, the value of the fillband_start_freq subtracting the copy_period circularly, until this value is in a value range of the sequence numbers of the source frequency segment, and this value being the source frequency segment replication starting sequence number, which is denoted as copy_pos_mod.

Preferably, in step C, a method for taking the spectral band replication period as the period, starting from the source frequency segment replication starting sequence number, periodically replicating frequency domain coefficients of the source frequency segment to the zero bit encoding subband is:

replicating frequency domain coefficients starting from source frequency segment replication starting sequence number backwards in sequence to the zero bit encoding subband starting from the fillband_start_freq, until a frequency point of source frequency segment replication arrives at a Tonal_pos+copyband_offset frequency point, continually replicating frequency domain coefficients starting from the copyband_offset th frequency point backwards to the zero bit encoding subband over again, and so forth, until completing the spectral band replication of all frequency domain coefficients of the current zero bit encoding subband.

In order to solve the above technical problem, the present invention also provides a device for spectral band replication, and this device comprises: a tone position searching module, a period and source frequency segment calculating module, a source frequency segment replication starting sequence number calculating module and a spectral band replicating module connected in sequence, wherein

the tone position searching module is for searching for position of a certain tone of an audio signal in MDCT frequency domain coefficients;

the period and source frequency segment calculating module is for according to the tone position, determining a spectral band replication period and a source frequency segment for replication, and this spectral band replication period is a bandwidth from a 0 frequency point to a frequency point of the tone position, and said source frequency segment is a frequency segment from a frequency point of the 0 frequency point shifting copyband_offset frequency points backwards to a frequency point of the frequency point of the tone position shifting copyband_offset frequency points backwards;

the source frequency segment replication starting sequence number calculating module is for according to the source frequency segment and a starting sequence number of a zero bit encoding subband which requires spectral band replication, calculating a source frequency segment replication starting sequence number of this zero bit encoding subband;

said spectral band replicating module is for taking the spectral band replication period as a period, starting from the source frequency segment replication starting sequence number, periodically replicating frequency domain coefficients of the source frequency segment to the zero bit encoding subband.

Preferably, a method for said tone position searching module searching the tone position is: taking absolute values or square values of MDCT frequency domain coefficients of a first frequency segment and carrying out smoothing filtering; and according to a result of the smoothing filtering, searching for position of a maximum extreme value of filtering output of the first frequency segment, and taking the position of this maximum extreme value as the position of the tone.

Preferably, an operation formula of said tone position searching module taking the absolute values of MDCT frequency domain coefficients of the first frequency segment to carry out the smoothing filtering is:

X_ampᵢ(k)=μX_ampᵢ₋₁(k)+(1−μ)| X̅ᵢ(k)|

or an operation of taking the square values of frequency domain coefficients of the first frequency segment to carry out the smoothing filtering is:

X_ampᵢ(k)=μX_ampᵢ₋₁(k−1)+(1−μ) X̅ᵢ(k)²

wherein μ is a smoothing filtering coefficient, X_ampᵢ(k) denotes filtering outputs of the kth frequency point of the ith frame, and X̅ᵢ(k) are MDCT coefficients after decoding of the kth frequency point of the ith frame, and when i=0, X_ampᵢ₋₁(k)=0.

Preferably, said first frequency segment is a frequency segment of low frequencies of which energy is more centralized determined according to spectrum statistic characteristic, wherein low frequencies refer to spectrum components less than half of total bandwidth of a signal.

Preferably, said tone position searching module directly searches for an initial maximum value from filtering outputs of frequency domain coefficients corresponding to the first frequency segment, and takes this maximum value as the maximum extreme value of filtering output of the first frequency segment.

Preferably, when said tone position searching module determines the maximum extreme value of filtering outputs, a segment in the first frequency segment is taken as a second frequency segment, and an initial maximum value is searched from the filtering outputs of the frequency domain coefficients corresponding to the second frequency segment, and according to a position of the frequency domain coefficient corresponding to this initial maximum value, different processes are carried out:

a. if this initial maximum value is the filtering output of the frequency domain coefficient of the lowest frequency of the second frequency segment, comparing this filtering output of the frequency domain coefficient of the lowest frequency of the second frequency segment with the filtering output of the frequency domain coefficient of a former one lower frequency in the first frequency segment, and comparing forwards in sequence, until the filtering output of the current frequency domain coefficient is greater than the filtering output of a former one frequency domain coefficient, and the filtering output of the current frequency domain coefficient being a finally determined maximum extreme value, or, comparing until the filtering output of the frequency domain coefficient of the lowest frequency of the first frequency segment is greater than the filtering output of a latter one frequency domain coefficient, and the filtering output of the frequency domain coefficient of the lowest frequency of the first frequency segment being the finally determined maximum extreme value;

b. if this initial maximum value is the filtering output of the frequency domain coefficient of the highest frequency of the second frequency segment, comparing this filtering output of the frequency domain coefficient of the highest frequency of the second frequency segment with the filtering output of the frequency domain coefficient of a latter one higher frequency in the first frequency segment, and comparing backwards in sequence, until the filtering output of the current frequency domain coefficient is greater than the filtering output of a latter one frequency domain coefficient, and the filtering output of the current frequency domain coefficient being the finally determined maximum extreme value, or, comparing until the filtering output of the frequency domain coefficient of the highest frequency of the first frequency segment is greater than the filtering output of a former one frequency domain coefficient, and the filtering output of the frequency domain coefficient of the highest frequency of the first frequency segment being the finally determined maximum extreme value;

c. if this initial maximum value is the filtering output of the frequency domain coefficient between the lowest frequency and the highest frequency in the second frequency segment, the frequency domain coefficient corresponding to this initial maximum value being the tone position, namely, this initial maximum value being the finally determined maximum extreme value.

Preferably, a process of said source frequency segment replication starting sequence number calculating module calculating the source frequency segment replication starting sequence number of the zero bit encoding subband which requires the spectral band replication comprises:

obtaining a sequence number of a start frequency point of the zero bit encoding subband which requires reconstructing frequency domain coefficients currently, which is denoted as a fillband_start_freq, and a sequence number of a frequency point corresponding to the tone being denoted as a Tonal_pos, a spectral band replication period being denoted as a copy_period, of which a value is equal to the Tonal_pos plus 1, and a source frequency segment starting sequence number being denoted as the copyband_offset, the value of the fillband_start_freq subtracting the copy_period circularly, until this value is in a value range of the sequence numbers of the source frequency segment, and this value being the source frequency segment replication starting sequence number, which is denoted as copy_pos_mod.

Preferably, when said spectral band replicating module carries out the spectral band replication, frequency domain coefficients starting from the source frequency segment replication starting sequence number are replicated backwards in sequence to the zero bit encoding subband starting from the fillband_start_freq, until a frequency point of source frequency segment replication arrives at a Tonal_pos+copyband_offset frequency point, frequency domain coefficients starting from the copyband_offset th frequency point are continually replicated backwards to the zero bit encoding subband over again, and so forth, until completing the replication of all frequency domain coefficients of the current zero bit encoding subband.

In order to solve the above technical problem, the present invention also provides a method for audio decoding, and the method comprises:

A. carrying out decoding and inverse quantization on each amplitude envelop encoded bit in a bit stream to be decoded to obtain an amplitude envelop of each encoding subband;

B. carrying out bit allocation on each encoding subband, and carrying out decoding and inverse quantization on non-zero bit encoding subbands to obtain frequency domain coefficients of the non-zero bit encoding subbands;

C. searching for position of a certain tone of an audio signal in MDCT frequency domain coefficients, taking a bandwidth from a 0 frequency point to a frequency point of the tone position as a spectral band replication period, taking a frequency segment from a frequency point of the 0 frequency point shifting copyband_offset frequency points backwards to a frequency point of the frequency point of the tone position shifting the copyband_offset frequency points backwards as a source frequency segment, carrying out spectral band replication on zero bit encoding subbands, and according to an amplitude envelop of a current encoding subband, carrying out energy adjustment on frequency domain coefficients obtained by replication, and combining noise filling, obtaining reconstructed frequency domain coefficients of the zero bit encoding subband, wherein said offset copyband_offset is greater than or equal to 0;

D. carrying out Inverse Modified Discrete Cosine Transform on frequency domain coefficients of non-zero bit encoding subbands and reconstructed frequency domain coefficients of zero bit encoding subbands to obtain a final audio signal.

Preferably, in step C, the following method is adopted to search for the position of the certain tone:

taking absolute values or square values of the frequency domain coefficients of first frequency segment and carrying out smoothing filtering; and

according to a result of the smoothing filtering, searching for position of a maximum extreme value of filtering outputs of first frequency segment, and taking the position of this maximum extreme value as the position of a certain tone.

Preferably, an operation formula of taking the absolute values of frequency domain coefficients of the first frequency segment to carry out the smoothing filtering is as follows:

X_ampᵢ(k)=μX_ampᵢ₋₁(k)+(1μ)| X̅ᵢ(k)|

or an operation formula of taking the square values of frequency domain coefficients of the first frequency segment to carry out the smoothing filtering is as follows:

X_ampᵢ(k)=μX_ampᵢ₋₁(k−1)+(1−μ) X̅ᵢ(k)²

wherein μ is a smoothing filtering coefficient, X_ampᵢ(k) denotes filtering outputs of the kth frequency point of the ith frame, and X̅ᵢ(k) are MDCT coefficients after decoding of the kth frequency point of the ith frame, and when i=0, X_ampᵢ₋₁(k)=0.

Preferably, said first frequency segment is a frequency segment of low frequencies of which energy is more centralized determined according to spectrum statistic characteristic, wherein low frequencies refer to spectrum components less than half of total bandwidth of a signal.

Preferably, the following method is adopted to determine the maximum extreme value of filtering outputs: directly searching for an initial maximum value from filtering outputs of frequency domain coefficients corresponding to the first frequency segment, and taking this maximum value as the maximum extreme value of filtering outputs of the first frequency segment.

Preferably, the following method is adopted to determine the maximum extreme value of filtering outputs:

taking a segment in the first frequency segment as a second frequency segment, and searching for an initial maximum value from the filtering outputs of the frequency domain coefficients corresponding to the second frequency segment, and according to a position of the frequency domain coefficient corresponding to this initial maximum value, carrying out different processes:

a. if this initial maximum value is the filtering output of the frequency domain coefficient of the lowest frequency of the second frequency segment, comparing this filtering output of the frequency domain coefficient of the lowest frequency of the second frequency segment with the filtering output of the frequency domain coefficient of a former one lower frequency in the first frequency segment, and comparing forwards in sequence, until the filtering output of the current frequency domain coefficient is greater than the filtering output of a former one frequency domain coefficient, and the filtering output of the current frequency domain coefficient being a finally determined maximum extreme value, or, comparing until the filtering output of the frequency domain coefficient of the lowest frequency of the first frequency segment is greater than the filtering output of a latter one frequency domain coefficient, and the filtering output of the frequency domain coefficient of the lowest frequency of the first frequency segment being the finally determined maximum extreme value;

b. if this initial maximum value is the filtering output of the frequency domain coefficient of the highest frequency of the second frequency segment, comparing this filtering output of the frequency domain coefficient of the highest frequency of the second frequency segment with the filtering output of the frequency domain coefficient of a latter one higher frequency in the first frequency segment, and comparing backwards in sequence, until the filtering output of the current frequency domain coefficient is greater than the filtering output of a latter one frequency domain coefficient, and the filtering output of the current frequency domain coefficient being the finally determined maximum extreme value, or, comparing until the filtering output of the frequency domain coefficient of the highest frequency of the first frequency segment is greater than the filtering output of a former one frequency domain coefficient, and the filtering output of the frequency domain coefficient of the highest frequency of the first frequency segment being the finally determined maximum extreme value;

c. if this initial maximum value is the filtering output of the frequency domain coefficient between the lowest frequency and the highest frequency in the second frequency segment, the frequency domain coefficient corresponding to this initial maximum value being the tone position, namely, this initial maximum value being the finally determined maximum extreme value.

Preferably, in step C, when the spectral band replication is carried out for a zero bit encoding subband, firstly according to the source frequency segment and a starting sequence number of the zero bit encoding subband which requires spectral band replication, a source frequency segment replication starting sequence number of this zero bit encoding subband is calculated, then the spectral band replication period is taken as a period, and starting from the source frequency segment replication starting sequence number, frequency domain coefficients of the source frequency segment are periodically replicated to the zero bit encoding subband.

Preferably, in step C, a method for calculating the source frequency segment replication starting sequence number of the zero bit encoding subband is:

obtaining a sequence number of a frequency point of a start MDCT frequency domain coefficient of the zero bit encoding subband which requires reconstructing frequency domain coefficients, which is denoted as a fillband_start_freq, and a sequence number of a frequency point corresponding to the tone being denoted as a Tonal_pos, a spectral band replication period being denoted as a copy_period, of which a value is equal to the Tonal_pos plus 1, and a spectral band replication offset is denoted as the copyband_offset, the value of the fillband_start_freq subtracting the copy_period circularly, until this value is in a value range of the sequence numbers of the source frequency segment, and this value being the source frequency segment replication starting sequence number, which is denoted as copy_pos_mod.

Preferably, in step C, a method for taking the spectral band replication period as the period, starting from the source frequency segment replication starting sequence number, periodically replicating frequency domain coefficients of the source frequency segment to the zero bit encoding subband is:

replicating frequency domain coefficients starting from the source frequency segment replication starting sequence number backwards in sequence to the zero bit encoding subband starting from the fillband_start_freq, until a frequency point of source frequency segment replication arrives at a Tonal_pos+copyband_offset frequency point, continually replicating frequency domain coefficients starting from the copyband_offset th frequency point backwards to the zero bit encoding subband over again, and so forth, until completing the spectral band replication of all frequency domain coefficients of the current zero bit encoding subband.

Preferably, the above method for spectral band replication combining a method for noise filling is adopted to carry out spectrum reconstruction for all zero bit encoding subbands, or a method for random noise filling is adopted to carry out spectrum reconstruction for zero bit encoding subbands below a certain frequency point, and a method for frequency domain coefficient replication combining noise filling is adopted to carry out spectrum reconstruction for zero bit encoding subbands above the certain frequency point.

In order to solve the above technical problem, the present invention also provides a system for audio decoding, and the system comprises: a bit stream demultiplexer (DeMUX), an amplitude envelop decoding unit, a bit allocating unit, a frequency domain coefficient decoding unit, a spectral band replicating unit, a noise filling unit, and an Inverse Modified Discrete Cosine Transform (IMDCT) unit, wherein:

said DeMUX is for separating amplitude envelop encoded bits, frequency domain coefficient encoded bits and noise level encoded bits from a bit stream to be decoded;

said amplitude envelop decoding unit, which is connected with the DeMUX, is for carrying out decoding and inverse quantization for the amplitude envelop encoded bits outputted by said bit stream demultiplexer to obtain an amplitude envelop of each encoding subband;

said bit allocating unit, which is connected with said amplitude envelop decoding unit, is for carrying out bit allocation to obtain the number of encoded bits allocated to each frequency domain coefficient of each encoding subband;

the frequency domain coefficient decoding unit, which is connected with the amplitude envelop decoding unit and the bit allocating unit, is for carrying out decoding, inverse quantization and inverse normalization for encoding subbands to obtain frequency domain coefficients;

said spectral band replicating unit, which is connected with said DeMUX, frequency domain coefficient decoding unit, amplitude envelop decoding unit, and bit allocating unit, is for searching for position of a certain tone of an audio signal in MDCT frequency domain coefficients, taking a bandwidth from a 0 frequency point to a frequency point of the tone position as a spectral band replication period, taking a frequency segment from a frequency point of the 0 frequency point shifting copyband_offset frequency points backwards to a frequency point of the frequency point of the tone position shifting copyband_offset frequency points backwards as a source frequency segment, carrying out spectral band replication on zero bit encoding subbands, wherein said offset copyband_offset is greater than or equal to 0; and is also for according to an amplitude envelop of a current encoding subband, carrying out energy adjustment on the frequency domain coefficients obtained by replication;

the noise filling unit, which is connected with the amplitude envelop decoding unit, bit allocating unit, and spectral band replicating unit, is for according to the amplitude envelop of the current zero bit encoding subband, filling noise for this encoding subband, to obtain reconstructed frequency domain coefficients of the zero bit encoding subband;

the IMDCT unit, which is connected with said noise filling unit, is for carrying out IMDCT on the frequency domain coefficients after the noise filling to obtain an audio signal.

Preferably, said spectral band replicating unit comprises: a tone position searching module, a period and source frequency segment calculating module, a source frequency segment replication starting sequence number calculating module and a spectral band replicating module connected in sequence, wherein:

the tone position searching module is for searching for position of a certain tone of an audio signal in MDCT frequency domain coefficients;

the period and source frequency segment calculating module is for according to the tone position, determining a spectral band replication period and a source frequency segment for replication, and this spectral band replication period is a bandwidth from a 0 frequency point to a frequency point of the tone position, and said source frequency segment is a frequency segment from a frequency point of the 0 frequency point shifting copyband_offset frequency points backwards to a frequency point of the frequency point of the tone position shifting the copyband_offset frequency points backwards;

the source frequency segment replication starting sequence number calculating module is for according to the source frequency segment and a starting sequence number of a zero bit encoding subband which requires spectral band replication, calculating a source frequency segment replication starting sequence number of this zero bit encoding subband;

said spectral band replicating module is for taking the spectral band replication period as a period, starting from the source frequency segment replication starting sequence number, periodically replicating frequency domain coefficients of the source frequency segment to the zero bit encoding subband.

Preferably, said tone position searching module adopts the following method to search for the tone position: taking absolute values or square values of MDCT frequency domain coefficients of first frequency segment and carrying out smoothing filtering; and according to a result of the smoothing filtering, searching for position of a maximum extreme value of filtering outputs of the first frequency segment, and taking the position of this maximum extreme value as the tone position.

Preferably, an operation formula of said tone position searching module taking the absolute values of MDCT frequency domain coefficients of the first frequency segment to carry out the smoothing filtering is:

X_ampᵢ(k)=μX_ampᵢ₋₁(k)+(1−μ)| X̅ᵢ(k)|

or an operation of taking the square values of frequency domain coefficients of the first frequency segment to carry out the smoothing filtering is:

X_ampᵢ(k)=μX_ampᵢ₋₁(k−1)+(1−μ) X̅ᵢ(k)²

wherein μ is a smoothing filtering coefficient, X_ampᵢ(k) denotes filtering outputs of the kth frequency point of the ith frame, and X̅ᵢ(k) are MDCT coefficients after decoding of the kth frequency point of the ith frame, and when i=0, X_ampᵢ₋₁(k)=0.

Preferably, said first frequency segment is a frequency segment of low frequencies of which energy is more centralized determined according to spectrum statistic characteristic, wherein low frequencies refer to spectrum components less than half of total bandwidth of a signal.

Preferably, said tone position searching module directly searches for an initial maximum value from filtering outputs of frequency domain coefficients corresponding to the first frequency segment, and takes this maximum value as the maximum extreme value of filtering outputs of the first frequency segment.

Preferably, when said tone position searching module determines the maximum extreme value of filtering outputs, a segment in the first frequency segment is taken as a second frequency segment, and an initial maximum value is searched from the filtering outputs of the frequency domain coefficients corresponding to the second frequency segment, and according to a position of the frequency domain coefficient corresponding to this initial maximum value, different processes are carried out:

a. if this initial maximum value is the filtering output of the frequency domain coefficient of the lowest frequency of the second frequency segment, comparing this filtering output of the frequency domain coefficient of the lowest frequency of the second frequency segment with the filtering output of the frequency domain coefficient of a former one lower frequency in the first frequency segment, and comparing forwards in sequence, until the filtering output of the current frequency domain coefficient is greater than the filtering output of a former one frequency domain coefficient, and the filtering output of the current frequency domain coefficient being a finally determined maximum extreme value, or, comparing until the filtering output of the frequency domain coefficient of the lowest frequency of the first frequency segment is greater than the filtering output of a latter one frequency domain coefficient, and the filtering output of the frequency domain coefficient of the lowest frequency of the first frequency segment being the finally determined maximum extreme value;

b. if this initial maximum value is the filtering output of the frequency domain coefficient of the highest frequency of the second frequency segment, comparing this filtering output of the frequency domain coefficient of the highest frequency of the second frequency segment with the filtering output of the frequency domain coefficient of a latter one higher frequency in the first frequency segment, and comparing backwards in sequence, until the filtering output of the current frequency domain coefficient is greater than the filtering output of a latter one frequency domain coefficient, and the filtering output of the current frequency domain coefficient being the finally determined maximum extreme value, or, comparing until the filtering output of the frequency domain coefficient of the highest frequency of the first frequency segment is greater than the filtering output of a former one frequency domain coefficient, and the filtering output of the frequency domain coefficient of the highest frequency of the first frequency segment being the finally determined maximum extreme value;

c. if this initial maximum value is the filtering output of the frequency domain coefficient between the lowest frequency and the highest frequency in the second frequency segment, the frequency domain coefficient corresponding to this initial maximum value being the tone position, namely, this initial maximum value being the finally determined maximum extreme value.

Preferably, a process of said source frequency segment replication starting sequence number calculating module calculating the source frequency segment replication starting sequence number of the zero bit encoding subband which requires the spectral band replication comprises:

obtaining a sequence number of a start frequency point of the zero bit encoding subband which requires reconstructing frequency domain coefficients currently, which is denoted as a fillband_start_freq, and a sequence number of a frequency point corresponding to the tone being denoted as a Tonal_pos, a spectral band replication period being denoted as a copy_period, of which a value is equal to the Tonal_pos plus 1, and a source frequency segment starting sequence number being denoted as the copyband_offset, the value of the fillband_start_freq subtracting the copy_period circularly, until this value is in a value range of the sequence numbers of the source frequency segment, and this value being the source frequency segment replication starting sequence number, which is denoted as copy_pos_mod.

Preferably, when said spectral band replicating module carries out the spectral band replication, frequency domain coefficients starting from the source frequency segment replication starting sequence number are replicated backwards in sequence to the zero bit encoding subband starting from the fillband_start_freq, until a frequency point of source frequency segment replication arrives at a Tonal_pos+copyband_offset frequency point, frequency domain coefficients starting from the copyband_offset th frequency point are continually replicated backwards to the zero bit encoding subband over again, and so forth, until completing the replication of all frequency domain coefficients of the current zero bit encoding subband.

Preferably, a method for frequency domain coefficient replication adopted by said spectral band replicating unit combining noise filling adopted by said noise filling unit is used to carry out spectrum reconstruction for all zero bit encoding subbands, or said noise filling unit carries out spectrum reconstruction for zero bit encoding subbands below a certain frequency point by adopting a method for random noise filling, and the method for the frequency domain coefficient replication adopted by said spectral band replicating unit combining noise filling adopted by said noise filling unit is used to carry out spectrum reconstruction for zero bit encoding subbands above the certain frequency point.

The present invention searches for the position of a certain tone of an audio signal in the MDCT frequency domain coefficients decoded by a decoding end of a system for audio encoding and decoding, and determines a frequency domain replication period according to this tone position, and then carries out the spectral band replication according to this frequency domain replication period, and combines energy level adjustment and noise filling to carry out frequency domain coefficient reconstruction on uncoded encoding subbands, wherein the energy level of noise filling and spectral band replication is controlled by the spectrum envelop values of uncoded encoding subbands. This method can well recover the spectrum envelop of the uncoded encoding subband and the internal tone information, and obtain a better subjective listening effect.

### BRIEF DESCRIPTION OF DRAWINGS

FIG. 1 is a schematic diagram of the method for spectral band replication according to the present invention;

FIG. 2 is a schematic diagram of the method for audio decoding according to the present invention;

FIG. 3 is a structure schematic diagram of the module of the device for spectral band replication according to the present invention;

FIG. 4 is a structure schematic diagram of the system for audio decoding according to the present invention.

### PREFERRED EMBODIMENTS OF THE PRESENT INVENTION

The core idea of the present invention is: searching for position of a certain tone of an audio signal in the MDCT frequency domain coefficients decoded by a decoding end of a system for audio encoding and decoding, and determining a frequency domain replication period according to this tone position, and then carrying out the spectral band replication according to this frequency domain replication period, and combining energy level adjustment and noise filling to carry out frequency domain coefficient reconstruction on uncoded encoding subbands, wherein the energy level of noise filling and spectral band replication is controlled by the spectrum envelop values of uncoded encoding subbands. This method can well recover the spectrum envelop of the uncoded encoding subband and the internal tone information, and obtain a better subjective listening effect.

All frequency domain coefficients said in the present invention refer to the MDCT frequency domain coefficients.

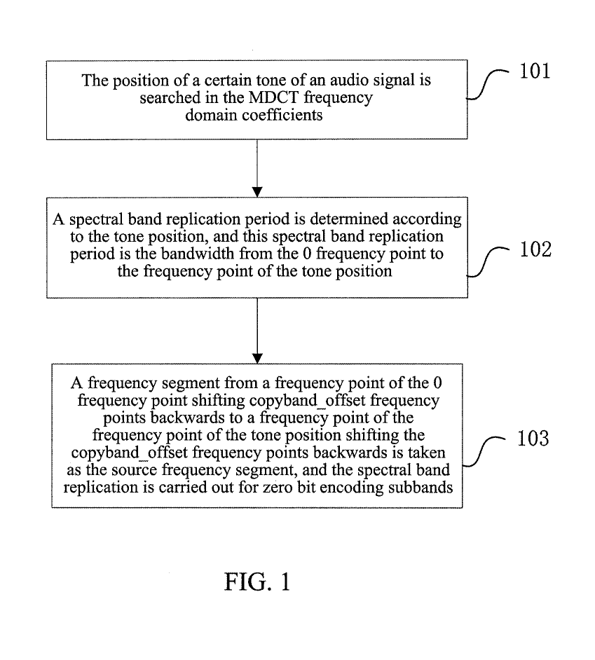

As shown in FIG. 1, the method for spectral band replication according to the present invention comprises:

101: the position of a certain tone of an audio signal is searched in the MDCT frequency domain coefficients;

the preferable method for searching for the tone position of the present invention is to carry out the smoothing filtering on the MDCT frequency domain coefficients, and the method comprises:

a1, absolute values or square values of the MDCT frequency domain coefficients are taken on a certain frequency segment of low frequencies, and smoothing filtering is carried out;

the certain frequency segment herein could be a frequency segment of low frequencies of which energy is more centralized determined according to the statistic characteristics of the spectrum, which is called the first frequency segment. The low frequency herein refers to the frequency components less than half of total bandwidth of a signal.

The MDCT frequency domain coefficients herein refer to the MDCT frequency domain coefficients decoded by the decoding end of the system for audio encoding and decoding, and are ranked from low frequency to high frequency, and the sequence number of the first frequency point is denoted as 0, and the sequence numbers of subsequent frequency points are added by 1 in sequence.

The operation formula of taking the absolute values of the frequency domain coefficients of the first frequency segment to carry out the smoothing filtering is as follows:

X_ampᵢ(k)=μX_ampᵢ₋₁(k)+(1−μ) X̅ᵢ(k)|

or, the operation formula of taking the square values of the frequency domain coefficients of the first frequency segment to carry out the smoothing filtering is as follows:

X_ampᵢ(k)=μX_ampᵢ₋₁(k)+(1−μ) X̅ᵢ(k)²

wherein μ is a smoothing filtering coefficient, and the value range is (0, 1), which could be 0.125. X_ampᵢ(k) denotes the filtering output of the kth frequency point of the ith frame, X̅ᵢ(k) denotes the MDCT coefficient after decoding of the kth frequency point of the ith frame, and when i=0, X_ampᵢ₋₁(k)=0.

a2. according to a result of the smoothing filtering, position of a maximum extreme value of the filtering outputs is searched, and the position of this maximum extreme value is taken as the tone position;

The tone of the audio signal said in this present invention is the pitch of an audio signal or a certain harmonic of the pitch.

There are following two methods for searching for the position of the maximum extreme value of filtering outputs of the first frequency segment:

(1) an initial maximum value is directly searched from the filtering outputs of the frequency domain coefficients corresponding to the first frequency segment, and this maximum value is taken as the maximum extreme value of the filtering outputs of the first frequency segment, and the sequence number of the corresponding frequency point is taken as the position of the maximum extreme value (namely the tone);

(2) during searching for the maximum extreme value, a segment in this first frequency segment is taken as the second frequency segment, and an initial maximum value is searched from the filtering outputs of the frequency domain coefficients corresponding to the second frequency segment, and this initial maximum value is taken as the maximum extreme value of the filtering outputs of the first frequency segment, and the sequence number of the corresponding frequency point is taken as the position of the maximum extreme value (namely the tone).

The start point position of the second frequency segment is greater than the start point of the first frequency segment, and the end point position of the second frequency segment is less than the end point of the first frequency segment, and preferably, the numbers of frequency domain coefficients in the first frequency segment and in the second frequency segment are not less than 8.

In order to avoid that the frequency domain coefficient corresponding to the searched initial maximum value is not the tone position of the audio signal, during searching for the tone position, firstly the initial maximum value is searched from the filtering outputs of this second frequency segment, and according to the position of the frequency domain coefficient corresponding to the initial maximum value, different processes are carried out:

(a) if this initial maximum value is the filtering output of the frequency domain coefficient of a lowest frequency of the second frequency segment, this filtering output of the frequency domain coefficient of the lowest frequency of the second frequency segment is compared with the filtering output of the frequency domain coefficient of a former one lower frequency in the first frequency segment, and comparing forwards in sequence, until the filtering output of the current frequency domain coefficient is greater than the filtering output of a former one frequency domain coefficient, and the current frequency domain coefficient is considered as the tone position, namely this filtering output of the current frequency domain coefficient is the finally determined maximum extreme value, or, until the filtering output of the frequency domain coefficient of a lowest frequency of the first frequency segment is greater than the filtering output of a latter one frequency domain coefficient by comparing, and the frequency domain coefficient of the lowest frequency of the first frequency segment is considered as the tone position, namely the filtering output of the frequency domain coefficient of the lowest frequency of the first frequency segment is the finally determined maximum extreme value;

(b) if this initial maximum value is the filtering output of the frequency domain coefficient of a highest frequency of the second frequency segment, this filtering output of the frequency domain coefficient of the highest frequency of the second frequency segment is compared with the filtering output of frequency domain coefficient of a latter one higher frequency in the first frequency segment, and comparing backwards in sequence, until the filtering output of the current frequency domain coefficient is greater than the filtering output of a latter one frequency domain coefficient, and the current frequency domain coefficient is considered as the tone position, namely this filtering output of the current frequency domain coefficient is the finally determined maximum extreme value, or, until the filtering output of the frequency domain coefficient of a highest frequency of the first frequency segment is greater than the filtering output of a former one frequency domain coefficient by comparing, and the frequency domain coefficient of the highest frequency of the first frequency segment is considered as the tone position, namely the filtering output of the frequency domain coefficient of the highest frequency of the first frequency segment is the finally determined maximum extreme value;

(c) if this initial maximum value is the filtering output of the frequency domain coefficient between the lowest frequency and the highest frequency in the second frequency segment, the frequency domain coefficient corresponding to this initial maximum value is the tone position, namely, this initial maximum value is the finally determined maximum extreme value.

Below it will describe the method for determining the audio signal position by taking that frequency domain coefficients of the first frequency segment are 24th to 64th MDCT frequency domain coefficients, and the frequency domain coefficients of the second frequency segment are the 33rd to the 56th MDCT frequency domain coefficients as an example:

the maximum value is searched from the filtering outputs of the 33rd to 56th MDCT frequency domain coefficients; if the maximum value corresponds to the 33rd frequency domain coefficient, it is judged whether the detected output result of the 32nd frequency domain coefficient is greater than that of the 33rd frequency domain coefficient, and if yes, comparison is continued forwards, and it is judged whether the detected output result of the 31st frequency domain coefficient is greater than that of the 32nd frequency domain coefficient, comparing in sequence forwards according to this method, until the filtering output of the current frequency domain coefficient is greater than that of a former one; or until finding the filtering output of the 24th frequency domain coefficient is greater than the filtering output of the 25th frequency domain coefficient, and then the current frequency domain coefficient or the 24th frequency domain coefficient is the tone position.

If the maximum value is the 56th, a similar method will be adopted to search backwards in sequence, until the filtering output of the current frequency domain coefficient is greater than that of a latter one, and the current frequency domain coefficient is the tone position; or until finding the filtering output of the 64th frequency domain coefficient is greater than the filtering output of the 63rd frequency domain coefficient, and then the 64th frequency domain coefficient is the tone position.

If the maximum value is between the 33rd and 56th, the frequency domain coefficient corresponding to this maximum value is the tone position.

The value of this position is denoted as Tonal_pos, namely the sequence number of the frequency point corresponding to the maximum extreme value.

102: a spectral band replication period is determined according to the tone position, and this spectral band replication period is the bandwidth from the 0 frequency point to the tone position frequency point;

The spectral band replication period is denoted as the copy_period, and the copy_period is equal to the Tonal_pos plus 1.

103: a frequency segment from a frequency point of the 0 frequency point shifting copyband_offset frequency points backwards to a frequency point of the frequency point of the tone position shifting copyband_offset frequency points backwards is taken as the source frequency segment, and the spectral band replication is carried out for zero bit encoding subbands.

The zero bit encoding subband said in the present invention refers to the encoding subbands to which 0 bit is allocated, and is also called uncoded encoding subband.

Namely, the starting sequence number of the frequency point of the source frequency segment is copyband_offset, and the end sequence number is copyband_offset+Tonal_pos.

In the present invention, the value of spectral band replication offset (denoted as the copyband_offset) is preset, copyband_offset≧0, and when the preset copyband_offset=0, the source frequency segment is the frequency segment from the 0 frequency point to the frequency point of tone position, and for the purpose of reducing the spectrum hopping of spectral band replication, the copyband_offset is set to greater than zero, and then the source frequency segment is the MDCT frequency domain coefficient from a frequency point of the 0 frequency point shifting a small range of frequency points backwards to a frequency point of the frequency point of frequency point of the maximum extreme value position shifting a same small range of frequency points backwards, and the spectrum filling of the zero bit encoding subbands above a certain frequency point is all replicated from the source frequency segment;

during carrying out the spectral band replication, firstly according to the source frequency segment and the starting sequence number of the zero bit encoding subband which requires the spectral band replication, the source frequency segment replication starting sequence number of this zero bit encoding subband is calculated, and then taking the spectral band replication period as the period, the frequency domain coefficients of the source frequency segment are periodically replicated to the zero bit encoding subband starting the source frequency segment replication starting sequence number.

A method for determining the source frequency segment replication starting sequence number is:

Firstly, starting from the first zero bit encoding subband which requires replicating, the sequence number of the frequency point of the start MDCT frequency domain coefficient of the zero bit encoding subband which requires reconstructing the frequency domain coefficients is obtained, which is denoted as the fillband_start_freq, and the sequence number of the frequency point corresponding to the tone is denoted as the Tonal_pos, and replication period copy_period is obtained by the Tonal_pos plus 1. And the spectral band replication offset is denoted as copyband_offset, and the value of the fillband_start_freq circularly subtracts the copy_period until the value falls into the value range of sequence number of the source frequency segment, and this value is the source frequency segment replication starting sequence number, which is denoted as the copy_pos_mod.

The source frequency segment replication starting sequence number copy_pos_mod can be obtained by the following pseudocode algorithm:

Setting the copy_pos_mod = fillband_start_freq;
When copy_pos_mod > (Tonal_pos + copyband_offset)
{

copy_pos_mod = copy_pos_mod − copy_period;

}

After completing the operation, the copy_pos_mod is the source frequency segment replication starting sequence number.

During the replication, the frequency domain coefficients starting from the source frequency segment replication starting sequence number are replicated backwards in sequence to the zero bit encoding subband which takes the fillband_start_freq as the start position, until the frequency point of source frequency segment replication arrives at the frequency point of the Tonal_pos+copyband_offset, and the frequency domain coefficients starting from the copyband_offset th frequency point are continually replicated backwards to this zero bit encoding subband over again, and the rest may be deduced by analogy, until completing the spectral band replication of all the frequency domain coefficients in the current zero bit encoding subband.

When the spectral band replication offset copyband_offset is set to 10, the frequency band starting from the copy_pos_mod is replicated to the zero bit encoding subband starting from the fillband_start_freq according to an order from the low frequency to high frequency, until after the Tonal_pos+10 frequency point, replication is started from the 10th frequency domain coefficient over again, and the rest may be deduced by analogy, and all the signals of this zero bit encoding subband are replicated from the 10 to Tonal_pos+10 frequency domain coefficients, and the frequency domain coefficients from the frequency points 10 to Tonal_pos+10 are the source frequency segment of the spectral band replication.

Adopting the method for spectral band replication of the present invention can replicate spectrum for all zero bit encoding subbands, and also can carry out the spectrum reconstruction by adopting a method for random noise filling for zero bit encoding subbands below a certain frequency point, and for the zero bit encoding subbands above the certain frequency point, adopting the method for frequency domain coefficients replication combining the noise filing to carry out the spectrum reconstruction.

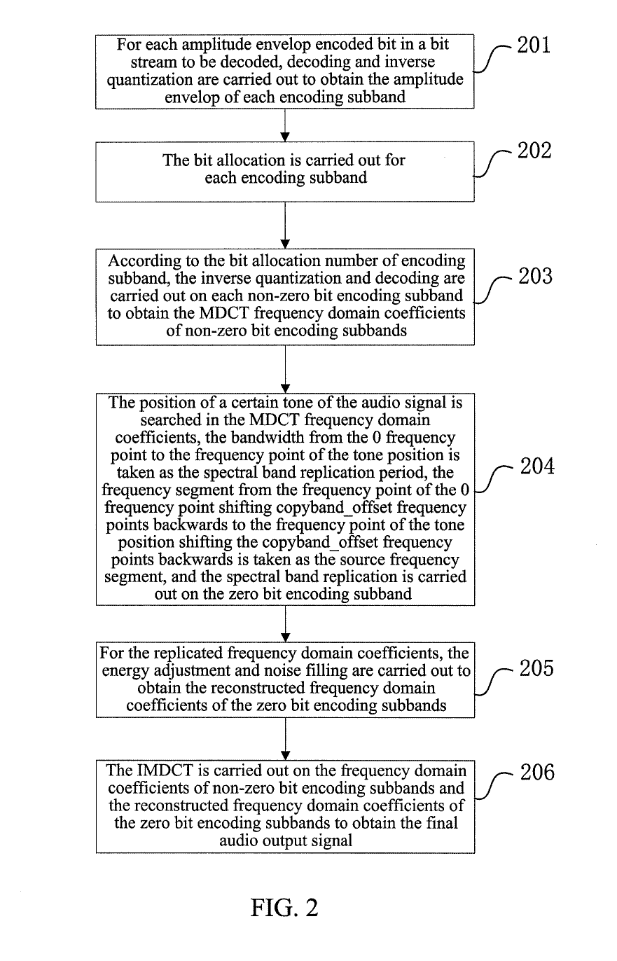

FIG. 2 is a structure schematic diagram of the method for audio decoding according to an example of the present invention. As shown in FIG. 4, this method comprises:

201: for each amplitude envelop encoded bits in a bit stream to be decoded, decoding and inverse quantization are carried out to obtain the amplitude envelop of each encoding subband;

encoded bits of one frame are extracted from the encoded bit stream transmitted from the encoding end (namely from the bit stream demultiplexer DeMUX); after extracting encoded bits, each amplitude envelop encoded bit in this frame is decoded to obtain the amplitude envelop quantitative index of each encoding subband Th_{q}(j), j=0, . . . , L−1. For the amplitude envelop quantitative index, the inverse quantization is carried out to obtain the amplitude envelop rms(r), r=0, . . . , L−1.

202: the bit allocation is carried out for each encoding subband;

an initial value of significance of each encoding subband is calculated according to the amplitude envelop quantitative index of each encoding subband, and the bit allocation is carried out by using the significance of encoding subband for each encoding subband to obtain the bit allocation number of encoding subbands; the method for bit allocation in the decoding end is completely same with that in the encoding end. In the process of bit allocation, the bit allocation step size and encoding subband significance reduced step size after bit allocation are variable.

203: according to the bit allocation number of the encoding subband, the inverse quantization and decoding are carried out on each non-zero bit encoding subband to obtain the MDCT frequency domain coefficients of non-zero bit encoding subbands;

204: the position of a certain tone of the audio signal is searched in the MDCT frequency domain coefficients, the bandwidth from the 0 frequency point to the frequency point of the tone position is taken as the spectral band replication period, the frequency segment from a frequency point of the 0 frequency point shifting copyband_offset frequency points backwards to a frequency point of the tone position shifting the copyband_offset frequency points backwards is taken as the source frequency segment, and the spectral band replication is carried out on the zero bit encoding subband; the detailed process of this step can be seen in the method for spectral band replication, and it will not give unnecessary details any more.

205: according to the amplitude envelop of the current encoding subband, the energy adjustment is carried out for the frequency domain coefficients obtained by replication, and combining the noise filling, the reconstructed frequency domain coefficients of the zero bit encoding subbands are obtained;

according to the noise level encoded bits transmitted by the encoding end, the energy adjustment is carried out for the frequency domain coefficients obtained by replication inside each zero bit encoding subband:

the amplitude envelop of frequency domain coefficients obtained by replication of zero bit encoding subband r is calculated, which is denoted as the sbr_rms(r).

The calculation formula of carrying out the energy adjustment on the frequency domain coefficients is:

X̅_̅{̅—̅}̅s̅b̅r̅(r)=X_{—}sbr(r)*sbr_{—}lev_scale(r)*rms(r)/sbr_{—}rms(r)

Wherein the X̅_̅s̅b̅r̅(r) denotes the frequency domain coefficients after the energy adjusting of the zero bit encoding subband r, the X_sbr(r) denotes the frequency domain coefficients obtained by replication of the zero bit encoding subband r, the sbr_rms(r) is the amplitude envelop (namely the root mean square) of the frequency domain coefficients obtained by replication X_sbr(r) of the zero bit encoding subband r, the rms(r) is the amplitude envelop of the frequency domain coefficients before encoding of the zero bit encoding subband r, and the sbr_lev_scale(r) is the energy gain control scale factor of the spectral band replication of the zero bit encoding subband r, and the value range is (0, 2). According to practical auditory perception, each subband can adopt the same or different coefficient values.

After completing the energy adjustment of the replicated frequency domain coefficients, the frequency domain coefficients after the energy adjusting are added by the white noise to generate the final reconstructed frequency domain coefficient X̅:

X̅(r)= X̅_̅{̅—̅}̅s̅b̅r̅(r)+rms(r)*noise_{—}lev_scale(r)*random( )

Wherein the X̅(r) denotes the reconstructed frequency domain coefficient of the zero bit encoding subband r, the X̅_̅s̅b̅r̅(r) denotes frequency domain coefficient after the energy adjusting of the zero bit encoding subband r, the rms(r) is the amplitude envelop of the frequency domain coefficients before encoding of the zero bit encoding subband r, the random( ) is the random phase value generated by the random phase generator, which generates random return values of +1 or −1, and the noise_lev_scale(r) is the noise level control scale factor of the zero bit encoding subband r, and the value range is (0, 2). According to the practical auditory perception, each subband can adopt the same or different coefficient values.

For frequency domain coefficients of the zero bit encoding subband of which the highest frequency is less than searched tone frequency, the method for noise filling is adopted to carry out the reconstruction.

The method for spectral band replication of the present invention can be adopted to carry out the spectrum reconstruction for all zero bit encoding subbands, and it also can adopt a method for random noise filing to carry out the spectrum reconstruction for zero bit encoding subbands below a certain frequency point, and adopt a method for frequency domain coefficient replication combining noise filling to carry out the spectrum reconstruction for zero bit encoding subbands above the certain frequency point.

206: the Inverse Modified Discrete Cosine Transform (IMDCT) is carried out on the frequency domain coefficients of non-zero bit encoding subbands and the reconstructed frequency domain coefficients of zero bit encoding subbands to obtain the final audio output signal.

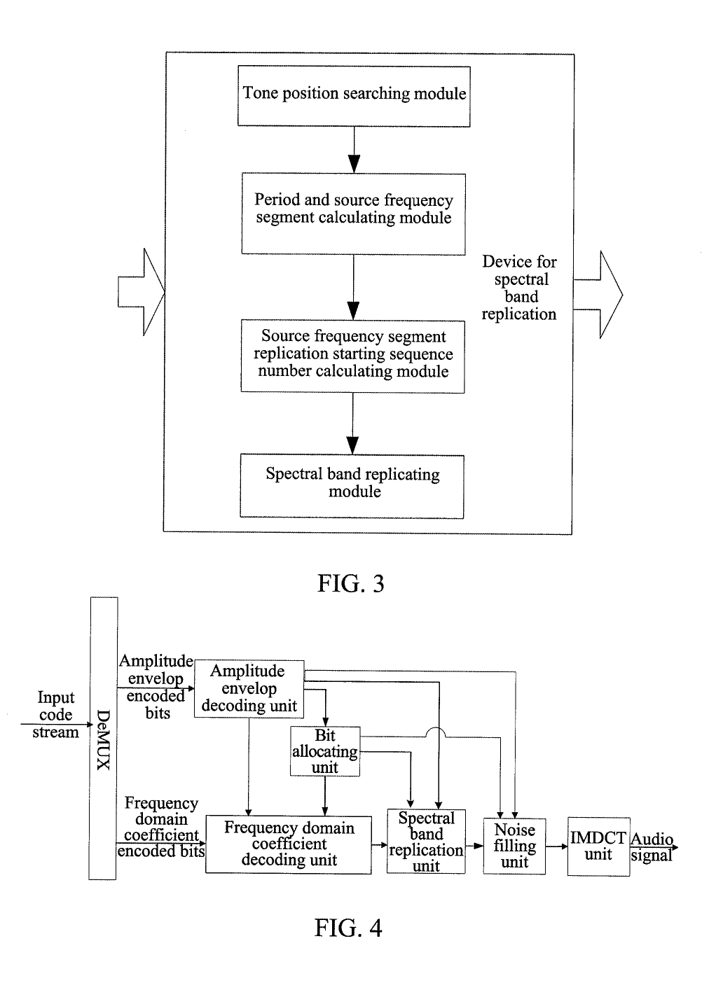

For implementing above method for the spectral band replication, the present invention also provides a device for the spectral band replication, as shown in FIG. 3, said device for the spectral band replication comprises a tone position searching module, a period and source frequency segment calculating module, a source frequency segment replication start index calculating module and a spectral band replicating module connected in sequence, wherein:

The tone position searching module is for searching for the position of a certain tone of an audio signal in the MDCT frequency domain coefficients, and specifically comprising: taking absolute values or square values of the MDCT frequency domain coefficients of the first frequency segment, and carrying out the smoothing filtering; and according to the result of the smoothing filtering, searching for the position of the maximum extreme value of filtering outputs of the first frequency segment, and position of this maximum value is the tone position;

The period and source frequency segment calculating module is for determining the spectral band replication period and the source frequency segment for the replication according to the tone position, and the spectral band replication period is the bandwidth from the 0 frequency point to the frequency point of the tone position, said source frequency segment is the frequency segment from a frequency point of the 0 frequency point shifting copyband_offset frequency points backwards to a frequency point of the frequency point of the tone position shifting said copyband_offset frequency points backwards;

if the sequence number of frequency point of the tone position is denoted as the Tonal_pos, the preset spectral band replication offset is denoted as the copyband_offset, and then the starting sequence number of the frequency domain coefficients of the source frequency segment is copyband_offset, and the end sequence number is copyband_offset+Tonal_pos.

The source frequency segment replication starting sequence number calculating module is for according to the source frequency segment and the starting sequence number of the zero bit encoding subband which requires the spectral band replication, calculating the source frequency segment replication starting sequence number of this zero bit encoding subband.

Said spectral band replicating module is for taking the spectral band replication period as a period, starting from the source frequency segment replication starting sequence number, periodically replicating the frequency domain coefficients of the source frequency segment to the zero bit encoding subband;

Preferably,

the operation formula of said tone position searching module taking the absolute value of the MDCT frequency domain coefficients of the first frequency segment to carry out the smoothing filtering is:

X_ampᵢ(k)=μX_ampᵢ₋₁(k)+(1−μ)| X̅ᵢ(k)|

Or, the operation of taking the square value of the frequency domain coefficients of the first frequency segment to carry out the smoothing filtering is:

X_ampᵢ(k)=μX_ampᵢ₋₁(k−1)+(1−μ) X̅ᵢ(k)²

Wherein μ is a smoothing filtering coefficient, X_ampᵢ(k) denotes the filtering outputs of the kth frequency point of the ith frame, and X̅ᵢ(n) are MDCT coefficients after decoding of the kth frequency point of the ith frame, and when i=0, X_ampᵢ₋₁(x)=0.

Preferably, said first frequency segment is a frequency segment of low frequencies of which the energy is more centralized determined according to the spectrum statistic characteristics, wherein the low frequencies refer to the frequency components less than half of total bandwidth of a signal.

Preferably, said tone position searching module directly searches for the initial maximum value from the filtering outputs of the frequency domain coefficients corresponding to the first frequency segment, and this maximum value is taken as the maximum extreme value of filtering outputs of the first frequency segment.

Preferably, when said tone position searching module determines the maximum extreme value of the filtering outputs, a segment in the first frequency segment is taken as the second frequency segment, and an initial maximum value is searched from the filtering outputs of the frequency domain coefficients corresponding to the second frequency segment, and according to the position of the frequency domain coefficient corresponding to this initial maximum, different processes are carried out:

a. if this initial maximum value is the filtering output of the frequency domain coefficient of a lowest frequency of the second frequency segment, this filtering output of the frequency domain coefficient of the lowest frequency of the second frequency segment is compared with the filtering output of the frequency domain coefficient of a former one lower frequency in the first frequency segment, and comparing forwards in sequence, until the filtering output of a current frequency domain coefficient is greater than the filtering output of a former one frequency domain coefficient, and the filtering output of the current frequency domain coefficient is the finally determined maximum extreme value, or, until the filtering output of the frequency domain coefficient of a lowest frequency of the first frequency segment is greater than the filtering output of a latter one frequency domain coefficient by comparing, and the filtering output of the frequency domain coefficient of the lowest frequency of the first frequency segment is the finally determined maximum extreme value;

b. if this initial maximum value is the filtering output of the frequency domain coefficient of a highest frequency of the second frequency segment, this filtering output of the frequency domain coefficient of the highest frequency of the second frequency segment is compared with the filtering output of the frequency domain coefficient of a latter one higher frequency in the first frequency segment, and comparing backwards in sequence, until the filtering output of the current frequency domain coefficient is greater than the filtering output of a latter one frequency domain coefficient, and then the filtering output of the current frequency domain coefficient is the finally determined maximum extreme value, or, until the filtering output of the frequency domain coefficient of a highest frequency of the first frequency segment is greater than the filtering output of a former one frequency domain coefficient by comparing, and the filtering output of the frequency domain coefficient of the highest frequency of the first frequency segment is the finally determined maximum extreme value;

c. if this initial maximum value is the filtering output of the frequency domain coefficient between the lowest frequency and the highest frequency in the second frequency segment, the frequency domain coefficient corresponding to this initial maximum value is the tone position, namely, this initial maximum value is the finally determined maximum extreme value.

Preferably, the process of said source frequency segment replication starting sequence number calculating module calculating the source frequency segment replication starting sequence number of this zero bit encoding subband which requires the spectral band replication comprises: obtaining the sequence number of the start frequency point of the zero bit encoding subband which requires reconstructing the frequency domain coefficient currently, which is denoted as the fillband_start_freq, and the sequence number of the frequency point corresponding to the tone being denoted as the Tonal_pos, and the spectral band replication period is denoted as the copyband_offset, of which the value is equal to the Tonal_pos plus 1, and the source frequency segment starting sequence number being denoted as the copyband_offset, and the value of the fillband_start_freq circularly subtracting the copy_period until the value falls into the value range of sequence number of the source frequency segment, and this value is the source frequency segment replication starting sequence number.

Preferably, said frequency band replicating module carrying out the spectral band replication specifically comprises:

the frequency domain coefficients starting from the source frequency segment replication starting sequence number are replicated backwards in sequence to the zero bit encoding subband starting from the fillband_start_freq, until the frequency point of the source frequency segment replication arrives at the frequency point Tonal_pos+copyband_offset, and the frequency domain coefficients starting from the copyband_offset th frequency point are continually replicated backwards to this zero bit encoding subband over again, and the rest may be deduced by analogy, until completing replication of all the frequency domain coefficients of the current zero bit encoding subband.

In order to implement the above decoding method, the present invention also provides a system for audio decoding, and as shown in FIG. 4, this system comprises: a bit stream demultiplexer (DeMUX), an amplitude envelop decoding unit, a bit allocating unit, a frequency domain coefficient decoding unit, a spectral band replicating unit, a noise filling unit, and an Inverse Modified Discrete Cosine Transform (IMDCT) unit, wherein:

The bit stream demultiplexer (DeMUX), is for separating the amplitude envelop encoded bits, frequency domain coefficient encoded bits and noise level encoded bits from a bit stream to be decoded;

The amplitude envelop decoding unit, which is connected with said bit stream demultiplexer, is for decoding and inversely quantizing the amplitude envelop encoded bits outputted by said bit stream demultiplexer to obtain the amplitude envelop of each encoding subband;

The bit allocating unit, which is connected with said amplitude envelop decoding unit, is for allocating bits, and obtaining encoded bit number allocated to each frequency domain coefficient in each encoding subband;

The bit allocating unit comprises: a significance calculating module, a bit allocating module and a bit allocation modifying module, wherein:

the significance calculating module is for calculating the initial value of significance of each encoding subband according to amplitude envelop quantitative index of the encoding subband;

said bit allocating module is for carrying out bit allocation on each frequency domain coefficient in the encoding subbands according to the initial value of significance of each encoding subband, and during the process of bit allocation, the bit allocation step size and the significance reduced step size after the bit allocation are variable;

the bit allocation modifying module is for after carrying out the bit allocation, modifying count value of the iteration times and the significance of each encoding subband according to the bit allocation of the encoding end, and then carrying out modification of bit allocation on the encoding subbands count times.

When said bit allocating module carries out the bit allocation, the bit allocation step size and the significance reduced step size after the bit allocation of the low bit encoding subbands are less than the bit allocation step size and the significance reduced step size after the bit allocation of the zero bit encoding subbands and high bit encoding subbands.

When said bit allocation modifying module carries out the bit modification, the bit modification step size and the significance reduced step size after the bit modification of the low bit encoding subbands are less than the bit modification step size and the significance reduced step size after the bit modification of the zero bit encoding subbands and high bit encoding subbands.

The frequency domain coefficient decoding unit, which is connected with the amplitude envelop decoding unit and the bit allocating unit, is for carrying out the decoding, inverse quantization and inverse normalization on the encoding subbands to obtain the frequency domain coefficients;

The spectral band replicating unit, which is connected with said DeMUX, frequency domain coefficient decoding unit, amplitude envelop decoding unit and bit allocating unit, is for searching for the position of a certain tone of the audio signal in the MDCT frequency domain coefficients, and taking the bandwidth from the 0 frequency point to the frequency point of the tone position as the spectral band replication period, or taking the frequency segment from a frequency point of the 0 frequency point shifting copyband_offset frequency points backwards to a frequency point of the tone position shifting the copyband_offset frequency points backwards as the source frequency segment, and carrying out the spectral band replication on the zero bit encoding subband; is also for carrying out the energy adjustment on frequency domain coefficients obtained after the energy adjustment according to the amplitude envelop of the current zero bit encoding subband.

The specific implement of this spectral band replicating unit is the same with that of the above device for spectral band replication, and it will not give unnecessary details any more.

The noise filling unit, which is connected with the amplitude envelop decoding unit, bit allocating unit and spectral band replicating unit, is for filling noise for this encoding subband according to the amplitude envelop of the current zero bit encoding subband, and obtaining reconstructed frequency domain coefficients of zero bit encoding subbands;

The above method for spectral band replication adopted by said spectral band replicating unit combines the method for noise filling by the noise filling unit to carry out the spectrum reconstruction for all zero bit encoding subbands; or said noise filling unit adopts the method for random noise filling to carry out the spectrum reconstruction for zero bit encoding subbands below a certain frequency point, and for the zero bit encoding subbands above the certain frequency point, the spectral band replicating unit adopts a method for frequency domain coefficients replication combining the noise filling by the noise filling unit to carry out the spectrum reconstruction.

The Inverse Modified Discrete Cosine Transform (IMDCT) unit, which is connected with said noise filling unit, is for carrying out the IMDCT on the frequency domain coefficients after the noise filling to obtain the audio signal.

What is claimed is:

1. A method for spectral band replication, comprising:
A. searching for a position of a certain tone of an audio signal in MDCT frequency domain coefficients;
B. according to the position of the tone, determining a spectral band replication period and a source frequency segment, this spectral band replication period being a bandwidth from a 0 frequency point to a frequency point of the tone position, and this source frequency segment being a frequency segment from a frequency point of the 0 frequency point shifting copyband_offset frequency points backwards to a frequency point of the frequency point of the tone position shifting the copyband_offset frequency points backwards, wherein said offset copyband_offset is greater than or equal to 0;
C. according to the spectral band replication period, carrying out the spectral band replication on zero bit encoding subbands.

2. The method as claimed in claim 1, wherein in step A, the following method is adopted to search for the position of the certain tone:
taking absolute values or square values of frequency domain coefficients of a first frequency segment and carrying out smoothing filtering; and
according to a result of the smoothing filtering, searching for a position of a maximum extreme value of filtering outputs of the first frequency segment, and taking the position of this maximum extreme value as the position of the certain tone.

3. The method as claimed in claim 2, wherein
an operation formula of taking the absolute values of the frequency domain coefficients of the first frequency segment to carry out the smoothing filtering is as follows:
X_ampᵢ(k)=μX_ampᵢ₋₁(k)+(1−μ) X̅ᵢ(k)|

or an operation formula of taking the square values of the frequency domain coefficients of the first frequency segment to carry out the smoothing filtering is as follows:
X_ampᵢ(k)=μX_ampᵢ₋₁(k−1)+(1μ) X̅ᵢ(k)²
wherein μ is a smoothing filtering coefficient, X_ampᵢ(k) denotes the filtering output of the kth frequency point of the ith frame, and X̅ᵢ(k) is the MDCT coefficient after decoding of the kth frequency point of the ith frame, and when i=0, X_ampᵢ₋₁ (k)=0.

4. The method as claimed in claim 2, wherein said first frequency segment is a frequency segment of low frequencies, of which energy is relatively centralized, determined according to spectrum statistic characteristic, wherein the low frequencies refer to spectrum components less than half of a total bandwidth of a signal.

5. The method as claimed in claim 2, wherein the following method is adopted to determine the maximum extreme value of the filtering outputs: directly searching for an initial maximum value in filtering outputs of the frequency domain coefficients corresponding to the first frequency segment, and taking this maximum value as the maximum extreme value of the filtering outputs of the first frequency segment.

6. The method as claimed in claim 2, wherein the following method is adopted to determine the maximum extreme value of the filtering outputs:
taking a segment in the first frequency segment as a second frequency segment, and searching for an initial maximum value in the filtering outputs of the frequency domain coefficients corresponding to the second frequency segment, and according to a position of the frequency domain coefficient corresponding to this initial maximum value, carrying out different processes:
a. if this initial maximum value is the filtering output of the frequency domain coefficient of the lowest frequency of the second frequency segment, comparing this filtering output of the frequency domain coefficient of the lowest frequency of the second frequency segment with the filtering output of the frequency domain coefficient of a former lower frequency in the first frequency segment, and comparing forwards in sequence, until the filtering output of a current frequency domain coefficient is greater than the filtering output of a former frequency domain coefficient, then the filtering output of the current frequency domain coefficient being a finally determined maximum extreme value, or, comparing until the filtering output of the frequency domain coefficient of the lowest frequency of the first frequency segment is greater than the filtering output of a latter frequency domain coefficient, then the filtering output of the frequency domain coefficient of the lowest frequency of the first frequency segment being the finally determined maximum extreme value;
b. if this initial maximum value is the filtering output of the frequency domain coefficient of the highest frequency of the second frequency segment, comparing this filtering output of the frequency domain coefficient of the highest frequency of the second frequency segment with the filtering output of the frequency domain coefficient of a latter higher frequency in the first frequency segment, and comparing backwards in sequence, until the filtering output of a current frequency domain coefficient is greater than the filtering output of a latter frequency domain coefficient, then the filtering output of the current frequency domain coefficient being the finally determined maximum extreme value, or, comparing until the filtering output of the frequency domain coefficient of the highest frequency of the first frequency segment is greater than the filtering output of a former frequency domain coefficient, then the filtering output of the frequency domain coefficient of the highest frequency of the first frequency segment being the finally determined maximum extreme value;
c. if this initial maximum value is the filtering output of a frequency domain coefficient between the lowest frequency and the highest frequency in the second frequency segment, then the frequency domain coefficient corresponding to this initial maximum value being the tone position, that is, this initial maximum value being the finally determined maximum extreme value.

7. The method as claimed claim 1, wherein in step C, when the spectral band replication is carried out for a zero bit encoding subband, firstly a source frequency segment replication starting sequence number of this zero bit encoding subband is calculated according to the source frequency segment and a starting sequence number of the zero bit encoding subband which requires the spectral band replication, and then starting from the source frequency segment replication starting sequence number, the frequency domain coefficients of the source frequency segment are periodically replicated to the zero bit encoding subband, with the spectral band replication period being a period.

8. The method as claimed in claim 7, wherein in the step C, a method for calculating the source frequency segment replication starting sequence number of the zero bit encoding subband is:
obtaining a sequence number of a frequency point of a start MDCT frequency domain coefficient of the zero bit encoding subband which requires reconstructing frequency domain coefficients, the sequence number being denoted as fillband_start_freq, and a sequence number of a frequency point corresponding to the tone being denoted as Tonal_pos, the spectral band replication period being denoted as copy_period, of which the value is equal to Tonal_pos plus 1, and a spectral band replication offset being denoted as copyband_offset, subtracting the copy_period from the value of the fillband_start_freq circularly, until this value falls into a value range of the sequence numbers of the source frequency segment, then this value being the source frequency segment replication starting sequence number, which is denoted as copy_pos_mod.

9. The method as claimed in claim 7, wherein in the step C, a method for starting from the source frequency segment replication starting sequence number, replicating the frequency domain coefficients of the source frequency segment periodically to the zero bit encoding subband with the spectral band replication period being a period is:
replicating frequency domain coefficients starting from the source frequency segment replication starting sequence number backwards in sequence to the zero bit encoding subband starting from fillband_start_freq, until a frequency point of the source frequency segment replication reaches a frequency point of Tonal_pos+copyband_offset, continually replicating frequency domain coefficients starting from the copyband_offset th frequency point backwards to the zero bit encoding subband, and so forth, until completing the spectral band replication of all frequency domain coefficients of the current zero bit encoding subband.

10. A device for spectral band replication, comprising: a tone position searching module, a period and source frequency segment calculating module, a source frequency segment replication starting sequence number calculating module and a spectral band replicating module connected in sequence, wherein
the tone position searching module is for searching for a position of a certain tone of an audio signal in MDCT frequency domain coefficients;
the period and source frequency segment calculating module is for determining a spectral band replication period and a source frequency segment for the replication according to the position of the tone, this spectral band replication period being a bandwidth from a 0 frequency point to a frequency point of the tone position, and said source frequency segment being a frequency segment from a frequency point of the 0 frequency point shifting copyband_offset frequency points backwards to a frequency point of the frequency point of the tone position shifting the copyband_offset frequency points backwards;
the source frequency segment replication starting sequence number calculating module is for calculating a source frequency segment replication starting sequence number of a zero bit encoding subband according to the source frequency segment and a starting sequence number of this zero bit encoding subband which requires the spectral band replication;
said spectral band replicating module is for starting from the source frequency segment replication starting sequence number, periodically replicating frequency domain coefficients of the source frequency segment to the zero bit encoding subband, with the spectral band replication period being a period.

11. The device as claimed in claim 10, wherein said tone position searching module directly searches for an initial maximum value in the filtering outputs of frequency domain coefficients corresponding to the first frequency segment, and takes this maximum value as the maximum extreme value of the filtering outputs of the first frequency segment.

12. The device as claimed in claim 10, wherein when said tone position searching module determines the maximum extreme value of filtering outputs, a segment in the first frequency segment is taken as a second frequency segment, and an initial maximum value is searched in the filtering outputs of the frequency domain coefficients corresponding to the second frequency segment, and according to a position of the frequency domain coefficient corresponding to this initial maximum value, different processes are carried out:
a. if this initial maximum value is the filtering output of the frequency domain coefficient of the lowest frequency of the second frequency segment, comparing this filtering output of the frequency domain coefficient of the lowest frequency of the second frequency segment with the filtering output of the frequency domain coefficient of a former lower frequency in the first frequency segment, and comparing forwards in sequence, until the filtering output of a current frequency domain coefficient is greater than the filtering output of a former frequency domain coefficient, then the filtering output of the current frequency domain coefficient being a finally determined maximum extreme value, or, comparing until the filtering output of the frequency domain coefficient of the lowest frequency of the first frequency segment is greater than the filtering output of a latter frequency domain coefficient, then the filtering output of the frequency domain coefficient of the lowest frequency of the first frequency segment being the finally determined maximum extreme value;
b. if this initial maximum value is the filtering output of the frequency domain coefficient of the highest frequency of the second frequency segment, comparing this filtering output of the frequency domain coefficient of the highest frequency of the second frequency segment with the filtering output of the frequency domain coefficient of a latter higher frequency in the first frequency segment, and comparing backwards in sequence, until the filtering output of a current frequency domain coefficient is greater than the filtering output of a latter frequency domain coefficient, then the filtering output of the current frequency domain coefficient being the finally determined maximum extreme value, or, comparing until the filtering output of the frequency domain coefficient of the highest frequency of the first frequency segment is greater than the filtering output of a former frequency domain coefficient, then the filtering output of the frequency domain coefficient of the highest frequency of the first frequency segment being the finally determined maximum extreme value;
c. if this initial maximum value is the filtering output of a frequency domain coefficient between the lowest frequency and the highest frequency in the second frequency segment, then the frequency domain coefficient corresponding to this initial maximum value being the tone position, that is, this initial maximum value being the finally determined maximum extreme value.

13. The device as claimed in claim 10, wherein
a process of said source frequency segment replication starting sequence number calculating module calculating the source frequency segment replication starting sequence number of the zero bit encoding subband which requires the spectral band replication comprises:
obtaining a sequence number of a start frequency point of the zero bit encoding subband which requires reconstructing frequency domain coefficients currently, the sequence number being denoted as fillband_start_freq, and a sequence number of a frequency point corresponding to the tone being denoted as Tonal_pos, the spectral band replication period being denoted as copy_period, of which the value is equal to Tonal_pos plus 1, and a source frequency segment starting sequence number being denoted as copyband_offset, subtracting the copy_period from the value of the fillband_start_freq circularly, until this value falls into a value range of the sequence numbers of the source frequency segment, then this value being the source frequency segment replication starting sequence number, which is denoted as copy_pos_mod.

14. The device as claimed in claim 10, wherein
when said spectral band replicating module carries out the spectral band replication, frequency domain coefficients starting from the source frequency segment replication starting sequence number are replicated backwards in sequence to the zero bit encoding subband starting from fillband_start_freq, until a frequency point of the source frequency segment replication reaches a frequency point of Tonal_pos+copyband_offset, frequency domain coefficients starting from the copyband_offset th frequency point are continually replicated backwards to the zero bit encoding subband, and so forth, until completing the replication of all frequency domain coefficients of the current zero bit encoding subband.

15. A method for audio decoding, comprising:
A. carrying out decoding and inverse quantization on each amplitude envelop encoded bit in a bit stream to be decoded to obtain an amplitude envelop of each encoding subband;
B. carrying out bit allocation on each encoding subband, and carrying out decoding and inverse quantization on non-zero bit encoding subbands to obtain frequency domain coefficients of the non-zero bit encoding subbands;
C. searching for a position of a certain tone of an audio signal in MDCT frequency domain coefficients, taking a bandwidth from a 0 frequency point to a frequency point of the tone position as a spectral band replication period, taking a frequency segment from a frequency point of the 0 frequency point shifting copyband_offset frequency points backwards to a frequency point of the frequency point of the tone position shifting the copyband_offset frequency points backwards as a source frequency segment, carrying out spectral band replication on zero bit encoding subbands, and according to an amplitude envelop of a current encoding subband, carrying out energy adjustment on the frequency domain coefficients obtained by the replication, and combining noise filling, obtaining reconstructed frequency domain coefficients of the zero bit encoding subband, wherein said offset copyband_offset is greater than or equal to 0;
D. carrying out Inverse Modified Discrete Cosine Transform on frequency domain coefficients of the non-zero bit encoding subbands and reconstructed frequency domain coefficients of the zero bit encoding subbands to obtain a final audio signal.

16. The method as claimed in claim 15, wherein in step C, the following method is adopted to search for the position of the certain tone:
taking absolute values or square values of the frequency domain coefficients of a first frequency segment and carrying out smoothing filtering; and
according to a result of the smoothing filtering, searching for a position of a maximum extreme value of filtering outputs of the first frequency segment, and taking the position of this maximum extreme value as the position of the certain tone.

17. The method as claimed in claim 16, wherein in step C, when the spectral band replication is carried out for a zero bit encoding subband, firstly a source frequency segment replication starting sequence number of this zero bit encoding subband is calculated according to the source frequency segment and a starting sequence number of the zero bit encoding subband which requires spectral band replication, then starting from the source frequency segment replication starting sequence number, frequency domain coefficients of the source frequency segment are periodically replicated to the zero bit encoding subband, with the spectral band replication period being a period.

18. The method as claimed in claim 15, wherein the above method for spectral band replication in combination with a method for noise filling is adopted to carry out spectrum reconstruction for all zero bit encoding subbands, or, a method for random noise filling is adopted to carry out spectrum reconstruction for zero bit encoding subbands below a certain frequency point, and a method for frequency domain coefficient replication in combination with noise filling is adopted to carry out spectrum reconstruction for zero bit encoding subbands above the certain frequency point.

19. A system for audio decoding, comprising: a bit stream demultiplexer (DeMUX), an amplitude envelop decoding unit, a bit allocating unit, a frequency domain coefficient decoding unit, a spectral band replicating unit, a noise filling unit, and an Inverse Modified Discrete Cosine Transform (IMDCT) unit, wherein
said DeMUX is for separating amplitude envelop encoded bits, frequency domain coefficient encoded bits and noise level encoded bits from a bit stream to be decoded;
said amplitude envelop decoding unit, which is connected with the DeMUX, is for carrying out decoding and inverse quantization for the amplitude envelop encoded bits outputted by said bit stream demultiplexer to obtain an amplitude envelop of each encoding subband;
said bit allocating unit, which is connected with said amplitude envelop decoding unit, is for carrying out bit allocation to obtain the number of encoded bits allocated to each frequency domain coefficient of each encoding subband;
the frequency domain coefficient decoding unit, which is connected with the amplitude envelop decoding unit and the bit allocating unit, is for carrying out decoding, inverse quantization and inverse normalization for encoding subbands to obtain frequency domain coefficients;
said spectral band replicating unit, which is connected with said DeMUX, frequency domain coefficient decoding unit, amplitude envelop decoding unit, and bit allocating unit, is for searching for a position of a certain tone of an audio signal in MDCT frequency domain coefficients, taking a bandwidth from a 0 frequency point to a frequency point of the tone position as a spectral band replication period, taking a frequency segment from a frequency point of the 0 frequency point shifting copyband_offset frequency points backwards to a frequency point of the frequency point of the tone position shifting the copyband_offset frequency points backwards as a source frequency segment, carrying out spectral band replication on zero bit encoding subbands, wherein said offset copyband_offset is greater than or equal to 0; and is also for according to an amplitude envelop of a current encoding subband, carrying out energy adjustment on the frequency domain coefficients obtained by the replication;
the noise filling unit, which is connected with the amplitude envelop decoding unit, bit allocating unit, and spectral band replicating unit, is for according to the amplitude envelop of the current zero bit encoding subband, filling noise for this encoding subband to obtain reconstructed frequency domain coefficients of the zero bit encoding subband;
the IMDCT unit, which is connected with said noise filling unit, is for carrying out IMDCT on the frequency domain coefficients after the noise filling to obtain an audio signal.

20. The system as claimed in claim 19, wherein said spectral band replicating unit comprises a tone position searching module, a period and source frequency segment calculating module, a source frequency segment replication starting sequence number calculating module and a spectral band replicating module connected in sequence, wherein
the tone position searching module is for searching for a position of a certain tone of an audio signal in the MDCT frequency domain coefficients;
the period and source frequency segment calculating module is for determining a spectral band replication period and a source frequency segment for replication according to the tone position, this spectral band replication period being a bandwidth from a 0 frequency point to a frequency point of the tone position, and said source frequency segment being a frequency segment from a frequency point of the 0 frequency point shifting copyband_offset frequency points backwards to a frequency point of the frequency point of the tone position shifting the copyband_offset frequency points backwards;
the source frequency segment replication starting sequence number calculating module is for calculating a source frequency segment replication starting sequence number of a zero bit encoding subband according to the source frequency segment and a starting sequence number of the zero bit encoding subband which requires the spectral band replication;
said spectral band replicating module is for starting from the source frequency segment replication starting sequence number, periodically replicating frequency domain coefficients of the source frequency segment to the zero bit encoding subband, with the spectral band replication period being a period.

21. The system as claimed in claim 19, wherein said tone position searching module adopts the following method to search for the tone position: taking absolute values or square values of the MDCT frequency domain coefficients of first frequency segment and carrying out smoothing filtering; and according to a result of the smoothing filtering, searching for a position of a maximum extreme value of filtering outputs of the first frequency segment, the position of this maximum extreme value being the tone position.

22. The system as claimed in claim 21, wherein when said tone position searching module determines the maximum extreme value of filtering outputs, a segment in the first frequency segment is taken as a second frequency segment, and an initial maximum value is searched in the filtering outputs of the frequency domain coefficients corresponding to the second frequency segment, and according to a position of the frequency domain coefficient corresponding to this initial maximum value, different processes are carried out:
a. if this initial maximum value is the filtering output of the frequency domain coefficient of the lowest frequency of the second frequency segment, comparing this filtering output of the frequency domain coefficient of the lowest frequency of the second frequency segment with the filtering output of the frequency domain coefficient of a former lower frequency in the first frequency segment, and comparing forwards in sequence, until the filtering output of a current frequency domain coefficient is greater than the filtering output of a former frequency domain coefficient, then the filtering output of the current frequency domain coefficient being a finally determined maximum extreme value, or, comparing until the filtering output of the frequency domain coefficient of the lowest frequency of the first frequency segment is greater than the filtering output of a latter frequency domain coefficient, then the filtering output of the frequency domain coefficient of the lowest frequency of the first frequency segment being the finally determined maximum extreme value;
b. if this initial maximum value is the filtering output of the frequency domain coefficient of the highest frequency of the second frequency segment, comparing this filtering output of the frequency domain coefficient of the highest frequency of the second frequency segment with the filtering output of the frequency domain coefficient of a latter higher frequency in the first frequency segment, and comparing backwards in sequence, until the filtering output of the current frequency domain coefficient is greater than the filtering output of a latter frequency domain coefficient, then the filtering output of the current frequency domain coefficient being the finally determined maximum extreme value, or, comparing until the filtering output of the frequency domain coefficient of the highest frequency of the first frequency segment is greater than the filtering output of a former frequency domain coefficient, then the filtering output of the frequency domain coefficient of the highest frequency of the first frequency segment being the finally determined maximum extreme value;
c. if this initial maximum value is the filtering output of a frequency domain coefficient between the lowest frequency and the highest frequency in the second frequency segment, then the frequency domain coefficient corresponding to this initial maximum value being the tone position, that is, this initial maximum value being the finally determined maximum extreme value.

23. The system as claimed in claim 19, wherein a method for frequency domain coefficient replication adopted by said spectral band replicating unit in combination with noise filling adopted by said noise filling unit is used to carry out spectrum reconstruction for all zero bit encoding subbands, or, a method for random noise filling adopted by said noise filling unit is used to carry out spectrum reconstruction for zero bit encoding subbands below a certain frequency point, and the method for the frequency domain coefficient replication adopted by said spectral band replicating unit in combination with noise filling adopted by said noise filling unit is used to carry out spectrum reconstruction for zero bit encoding subbands above the certain frequency point.
